(19) United States
(12) Patent Application Publication
(10) Pub. No.: US 2019/0330408 A1
(43) Pub. Date: Oct. 31, 2019

(54) IONICALLY HYDROPHILIZED POLYISOCYANATES AND RADICAL SCAVENGERS AND/OR PEROXIDE DECOMPOSERS

(71) Applicant: COVESTRO DEUTSCHLAND AG, Leverkusen (DE)

(72) Inventor: Hans-Josef LAAS, Odenthal (DE)

(21) Appl. No.: 16/391,796

(22) Filed: Apr. 23, 2019

(30) Foreign Application Priority Data
Apr. 25, 2018 (EP) 18169342.5

(51) Int. Cl. C08G 18/80; C08K 5/13; C08K 5/134; C09D 175/04; C09D 5/00

(52) U.S. Cl. CPC C08G 18/8096; C08G 18/8083; C08G 18/807; C08K 2201/012; C08K 5/134; C09D 175/04; C09D 5/00; C08K 5/13

(57) ABSTRACT

The invention relates to a process for producing polyisocyanates containing sulfonate groups, the products obtainable by said process and also to the use thereof as starting component for producing polyurethane plastics. The invention further relates to coating compositions comprising polyisocyanates containing sulfonate groups and also to the substrates coated with said coating compositions.

### CROSS REFERENCE TO RELATED APPLICATIONS

This Paris Convention Patent Application claims benefit under 35 U.S.C. § 119 and claims priority to European Patent Application No. 18169342.5, filed on Apr. 25, 2018, titled “IONICALLY HYDROPHILIZED POLYISOCYANATES AND RADICAL SCAVENGERS AND/OR PEROXIDE DECOMPOSERS”, the contents of which are incorporated herein in their entirety by reference for all purposes.

### FIELD OF THE INVENTION

The invention relates to a process for producing polyisocyanates containing sulfonate groups, the polyisocyanates containing sulfonate groups obtainable or obtained by said process and to the use of these for producing polyurethane plastics. The invention further relates to coating compositions comprising the polyisocyanates containing sulfonate groups and also to the substrates coated with said coating compositions.

### BACKGROUND OF THE INVENTION

Aqueous coating systems are nowadays firmly established for various fields of application as an eco-friendly alternative to solvent-borne coating compositions. In this case, hydrophilically modified polyisocyanates play a particular role as raw material for qualitatively high-value aqueous coatings since, as water-dispersible crosslinker components, they enable the formulation of aqueous two-component polyurethane (2K-PUR) coatings.

A very simple method for producing water-dispersible polyisocyanates is, for example, the partial reaction of hydrophobic polyisocyanates with hydrophilic polyether alcohols (see e.g. EP-A 0 959 087, page 2, lines 25-46). However, polyether-modified polyisocyanates have the principal disadvantage that the high polyether content required for sufficient dispersibility for use as crosslinker in aqueous 2K-PUR coatings imparts permanent hydrophilicity to the coatings obtained.

To circumvent this disadvantage, it has already been attempted to produce hydrophilically modified self-dispersible polyisocyanates by incorporation of ionic groups, particularly sulfonate groups.

EP 703 255 describes, for example, water-emulsifiable polyisocyanates having aliphatically, cycloaliphatically or aromatically bonded NCO groups, which are hydrophilically modified by reaction with compounds containing sulfonate groups, as additives for aqueous dispersions. Suitable hydrophilization units mentioned in this publication are hydroxy- or aminosulfonic acids, particularly those having aliphatically bonded OH groups such as, e.g. hydroxyethanesulfonic acid or hydroxypropanesulfonic acid, or polyether sulfonates, e.g. Tegomer® polyether (Goldschmidt). WO 2009/010469 describes the use of aromatic sulfonic acids bearing exactly one primary or secondary amino group and having a specific substitution pattern, in combination with monofunctional polyether alcohols, for hydrophilization of di- or polyisocyanates.

US 2009/0209711 likewise relates to ionically/non-ionically modified water-dispersible polyisocyanates, produced using hydrophilic methoxypolyethylene glycols, specific hydrophobic polyether alcohols and polyester alcohols containing alkali-neutralized sulfonate groups.

JP 2015-205957 and JP 2016-017157 describe hydroxy-functional sulfonic acid ammonium salts, preferably those based on hydroxyethanesulfonic acid, hydroxypropanesulfonic acid or hydroxymethylbenzenesulfonic acid which, as neutralizing amine, comprise tertiary amines having at least one cyclic substituent, and reaction products thereof having aliphatic, cycloaliphatic or araliphatic polyisocyanates.

According to the teaching of WO 2001/88006, hydrophilized polyisocyanates can be obtained by reacting any polyisocyanates with 2-(cyclohexylamino)ethanesulfonic acid (CHES) or 3-(cyclohexylamino)propanesulfonic acid (CAPS) which, as crosslinkers in aqueous coating systems, result in coatings with high hardness and excellent solvent and chemical resistance.

EP 3 045 485 A1 describes the use of further aminopropane-, aminobutane- and/or aminoisobutanesulfonic acids, substituted by cycloaliphatics on the nitrogen, as hydrophilizing agents for polyisocyanates.

It is known that sulfonic acid groups can react with one another, in the presence of water-withdrawing compounds such as isocyanates, to give sulfonic anhydrides or also with isocyanate groups to give mixed anhydrides of sulfonic acids and carbamic acids, so-called carbamoyl sulfonates. In the process described above for producing polyisocyanate crosslinkers containing sulfonate groups, these secondary reactions always result in an increase in the viscosity, at the same time reducing the number of acid groups imparting hydrophilicity and thus reducing the emulsifiability of the reaction products.

Moreover, it is known to those skilled in the art that the incorporation of sulfonic acid or sulfonate groups in polyisocyanates often leads to a deterioration of the color number.

To formulate aqueous two-component polyurethane coatings of the highest quality, light-coloured polyisocyanate crosslinkers of the lowest possible viscosity and highest possible hydrophilicity are required straight from the market which can be readily stirred into the aqueous phase.

### SUMMARY OF THE INVENTION

The present invention therefore provides novel polyisocyanates containing sulfonate groups which, compared to those currently known, have a significantly reduced colour number, lower viscosities and at the same time an improved incorporability in aqueous systems.

This is achieved with the polyisocyanates containing sulfonate groups and the method for the production thereof described in more detail below. The present invention is based on the surprising observation that the reaction of polyisocyanates with compounds containing sulfonic acid or sulfonate groups affords products with distinctly lower colour when the reaction is carried out in the presence of customary radical scavengers and/or peroxide decomposers. It was particularly surprising that the hydrophilic polyisocyanates produced with concomitant use of radical scavengers and/or peroxide decomposers exhibit higher isocyanate contents, lower viscosities and better emulsifiability in direct comparison with polyisocyanates containing sulfonate groups analogously formed such as were obtained by the production processes currently known without concomitant use of radical scavengers and/or peroxide decomposers.

### DETAILED DESCRIPTION OF THE INVENTION

The present invention relates to a process for producing polyisocyanates containing sulfonate groups, comprising a reaction of
A) at least one polyisocyanate component having aliphatically, cycloaliphatically, araliphatically and/or aromatically bonded isocyanate groups with
B) at least one organic compound bearing at least one group reactive to isocyanate groups, which comprises one or more sulfonic acid and/or sulfonate groups, wherein the sulfonic acid groups are neutralized at least partially during and/or subsequent to the reaction of A) with B), and optionally
C) further non-ionic hydrophilic or hydrophobic organic compounds having at least one group reactive to isocyanates,

characterized in that,

the reaction of the polyisocyanate component A) with the organic compound B) is carried out in the presence of at least one radical scavenger and/or peroxide decomposer D).

The invention also relates to the polyisocyanates containing sulfonate groups obtainable by this process and also to the use thereof as starting components for the production of polyurethane plastics, particularly as crosslinkers for water-soluble or water-dispersible paint binders or paint binder components, having groups reactive to isocyanate groups in the production of coatings using aqueous coating compositions based on such binders or binder components.

According to the invention the terms “comprising” or “containing” preferably mean “consisting essentially of” and particularly preferably mean “consisting of”.

A further preferred embodiment of the present invention is a process for producing polyisocyanates containing sulfonate groups, comprising a reaction of

A) at least one polyisocyanate component having aliphatically, cycloaliphatically, araliphatically and/or aromatically bonded isocyanate groups with

B) at least one organic compound bearing at least one group reactive to isocyanate groups, which comprises one or more sulfonic acid and/or sulfonate groups, wherein the sulfonic acid groups are neutralized at least partially during and/or subsequent to the reaction of A) with B), and optionally

C) at least one non-ionic hydrophilic organic compound having at least one group reactive to isocyanates and/or at least one hydrophobic organic compound having at least one group reactive to isocyanates, characterized in that, the reaction of the polyisocyanate component A) with the organic compound B) is carried out in the presence of at least one radical scavenger and/or peroxide decomposer D).

Starting compounds A) for the process according to the invention are any diisocyanates and/or polyisocyanates having aliphatically, cycloaliphatically, araliphatically and/or aromatically bonded isocyanate groups.

Suitable diisocyanates A) are any diisocyanates accessible in various ways, for example by phosgenation in the liquid or gas phase or by a phosgene-free route, for example by thermal urethane cleavage. Preferred diisocyanates are those from the molecular weight range of 140 to 400 having aliphatically, cycloaliphatically, araliphatically and/or aromatically bonded isocyanate groups, examples being 1,4-diisocyanatobutane, 1,5-diisocyanatopentane (PDI), 1,6-diisocyanatohexane (HDI), 2-methyl-1,5-diisocyanatopentane, 1,5-diisocyanato-2,2-dimethylpentane, 2,2,4- or 2,4,4-trimethyl-1,6-diisocyanatohexane, 1,10-diisocyanatodecane, 1,3- and 1,4-diisocyanatocyclohexane, 1,3- and 1,4-bis(isocyanatomethyl)cyclohexane, 1-isocyanato-3,3,5-trimethyl-5-isocyanatomethylcyclohexane (isophorone diisocyanate, IPDI), 4,4′-diisocyanatodicyclohexylmethane, 1-isocyanato-1-methyl-4(3)isocyanatomethylcyclohexane, bis(isocyanatomethyl)norbornane, 1,3- and 1,4-bis(2-isocyanatoprop-2-yl)benzene (TMXDI), 2,4- and 2,6-diisocyanatotoluene (TDI), 2,4′- and 4,4′-diisocyanatodiphenylmethane (MDI), 1,5-diisocyanatonaphthalene or any mixtures of such diisocyanates.

Suitable polyisocyanates A) are any polyisocyanates having uretdione, isocyanurate, allophanate, biuret, iminooxadiazinedione and/or oxadiazinetrione structure, produced by modification of simple aliphatic, cycloaliphatic, araliphatic and/or aromatic diisocyanates, for example those of the type mentioned above, as described for example in J. Prakt. Chem. 336 (1994) 185-200, in DE-A 1 670 666, DE-A 1 954 093, DE-A 2 414 413, DE-A 2 452 532, DE-A 2 641 380, DE-A 3 700 209, DE-A 3 900 053 and DE-A 3 928 503 or in EP-A 0 336 205, EP-A 0 339 396 and EP-A 0 798 299 or by mixtures of any such polyisocyanates. In the course of production of these polyisocyanates, the actual modification reaction is generally followed by a further process step for removing the unreacted excess monomeric diisocyanates. The monomers are removed by processes known per se, preferably by thin-film distillation under high vacuum or by extraction with suitable solvents inert to isocyanate groups, for example aliphatic or cycloaliphatic hydrocarbons such as pentane, hexane, heptane, cyclopentane or cyclohexane.

In the process according to the invention, polyisocyanates of the type mentioned are preferably used as starting component A) having a content of monomeric diisocyanates of less than 1% by weight, preferably less than 0.5% by weight, particularly preferably less than 0.3% by weight. The residual monomer contents are measured according to DIN EN ISO 10283:2007-11 by gas chromatography with an internal standard.

Particularly preferred polyisocyanates A) for the process according to the invention are those of the type mentioned having exclusively aliphatically and/or cycloaliphatically bonded isocyanate groups.

Especially preferred polyisocyanates A) are based on PDI, HDI, IPDI and/or 4,4′-diisocyanatodicyclohexylmethane.

The polyisocyanates A) mentioned above as suitable, preferred, particularly preferred and especially particularly preferred preferably comprise isocyanurate structures and have an average NCO functionality of 2.3 to 5.0, preferably of 2.5 to 4.5, and a content of isocyanate groups of 6.0 to 26.0% by weight, preferably 8.0 to 25.0% by weight, particularly preferably 10.0 to 24.0% by weight.

Starting compounds B) for the process according to the invention are any organic compounds bearing at least one group that is reactive to isocyanate groups and one or more sulfonic acid or sulfonate groups. These are hydroxy-, mercapto- or amino-functional sulfonic acids and/or salts thereof known per se or are mixtures of any such compounds.

Suitable starting compounds B) are, for example, hydroxysulfonic acids of the general formula (I)

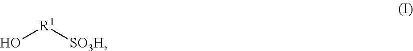

in which R¹ is an alkyl or aryl radical having up to 10 carbon atoms, which may comprise ester groups, carbonyl groups, up to two tertiary amino groups and/or hydroxyl groups, or is a five- or six-membered cycloaliphatic radical, which may optionally comprise nitrogen or oxygen atoms and may also be substituted by further hydroxyl groups.

Examples of suitable hydroxysulfonic acids include: 2-hydroxyethanesulfonic acid, 3-hydroxypropanesulfonic acid, 4-hydroxybutanesulfonic acid, 5-hydroxypentanesulfonic acid, 6-hydroxyhexanesulfonic acid, isomeric phenolsulfonic acids, especially 4-hydroxybenzenesulfonic acid, 2-(hydroxymethyl)benzenesulfonic acid, 3,5-bis(hydroxymethyl)benzenesulfonic acid, 4-(2-hydroxyethyl)-1-piperazineethanesulfonic acid (HEPES), 4-(2-hydroxyethyl)-1-piperazinepropanesulfonic acid (HEPPS) and 2-hydroxy-4-morpholinepropanesulfonic acid (MOPSO).

Suitable hydroxysulfonic acids are also specific polyethersulfonic acids, such as are described as detergents, for example, in EP-A 0 592 073, U.S. Pat. Nos. 3,102,893 and 2,989,547.

Preferred hydroxysulfonic acids B) for the process according to the invention are those of the general formula (I), in which R¹ is an alkyl group having up to 6 carbon atoms or an aryl group having 6 to 10 carbon atoms.

Particularly preferred hydroxysulfonic acids B) used are 2-hydroxyethanesulfonic acid, 3-hydroxypropanesulfonic acid, 4-hydroxybenzenesulfonic acid and/or 2-(hydroxymethyl)benzenesulfonic acid.

Suitable starting compounds B) are also mercaptosulfonic acids such as 2-mercaptoethanesulfonic acid and 3-mercaptopropane-1-sulfonic acid.

Amino-functional compounds suitable as starting component B) are, for example, substituted aromatic sulfonic acids, which may bear up to three sulfonic acid groups and comprise up to three, preferably up to two, particularly preferably precisely one primary or secondary, preferably precisely one primary amino group, wherein the positions on the aromatic ring in the position ortho to the amino group are unsubstituted.

These are preferably substituted aromatic sulfonic acids of the general formula (II)

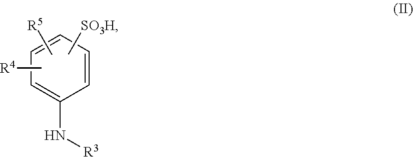

in which R³, R⁴ and R⁵ are each independently identical or different radicals and denote hydrogen or saturated or unsaturated, linear or branched, aliphatic, cycloaliphatic, araliphatic or aromatic organic radicals, which may additionally comprise heteroatoms in the chain, wherein R⁴ and R⁵ may together also form a ring, preferably a fused aromatic ring, in combination with each other, with the proviso that at least one of the radicals R⁴ and R⁵ is not hydrogen.

Aliphatic or araliphatic radicals R³, R⁴ and R⁵ in formula (II) are preferably those having 1 to 18 carbon atoms such as a methyl, ethyl, propyl, isopropyl, n-butyl, sec-butyl, tert-butyl, pentyl, hexyl, heptyl, octyl, 2-ethylhexyl, 2,4,4-trimethylpentyl, decyl, dodecyl, tetradecyl, heptadecyl, octadecyl, 1,1-dimethylpropyl, 1,1-dimethylbutyl, 1,1,3,3-tetramethylbutyl, benzyl, 1-phenylethyl, 2-phenylethyl, α,α-dimethylbenzyl, benzhydryl, p-tolylmethyl, 1-(p-butylphenyl)ethyl, p-chlorobenzyl, 2,4-dichlorobenzyl, p-methoxybenzyl, m-ethoxybenzyl, 2-cyanoethyl, 2-cyanopropyl, 2-methoxycarbonethyl, 2-ethoxycarbonylethyl, 2-butoxycarbonylpropyl, 1,2-di(methoxycarbonyl)ethyl, 2-methoxyethyl, 2-ethoxyethyl, 2-butoxyethyl, diethoxymethyl, diethoxyethyl, 1,3-dioxolan-2-yl, 1,3-dioxan-2-yl, 2-methyl-1,3-dioxolan-2-yl-, 4-methyl-1,3-dioxolan-2-yl, 2-isopropoxyethyl, 2-butoxypropyl, 2-octyloxyethyl, chloromethyl, 2-chloroethyl, trichloromethyl, trifluoromethyl, 1,1-dimethyl-2-chloroethyl, 2-methoxyisopropyl, butylthiomethyl, 2-dodecylthioethyl, 2-phenylthioethyl, 2,2,2-trifluoroethyl, 2-phenoxyethyl, 2-phenoxypropyl, 3-phenoxypropyl, 4-phenoxybutyl, 6-phenoxyhexyl, 2-methoxyethyl, 2-methoxypropyl, 3-methoxypropyl, 4-methoxybutyl, 6-methoxyhexyl, 2-ethoxypropyl, 3-ethoxypropyl, 4-ethoxybutyl or 6-ethoxyhexyl radical.

Cycloaliphatic radicals R³, R⁴ and R⁵ in formula (II) are preferably those having 5 to 12 carbon atoms such as, e.g. a cyclopentyl, cyclohexyl, cyclooctyl, cyclododecyl, methylcyclopentyl, dimethylcyclopentyl, methylcyclohexyl, dimethylcyclohexyl, diethylcyclohexyl, butylcyclohexyl, methoxycyclohexyl, dimethoxycyclohexyl, diethoxycyclohexyl, butylthiocyclohexyl, chlorocyclohexyl, dichlorocyclohexyl, dichlorocyclopentyl radical and also saturated or unsaturated bicyclic systems such as, e.g. a norbornyl or a norbornenyl radical.

Aromatic radicals R³, R⁴ and R⁵ in formula (II) are preferably those having 6 to 12 carbon atoms such as, e.g. a phenyl, tolyl, xylyl, o-naphthyl, β-naphthyl, 4-diphenylyl, chlorophenyl, dichlorophenyl, trichlorophenyl, difluorophenyl, methylphenyl, dimethylphenyl, trimethylphenyl, ethylphenyl, diethylphenyl, isopropylphenyl, tert-butylphenyl, dodecylphenyl, methoxyphenyl, dimethoxyphenyl, ethoxyphenyl, hexyloxyphenyl, methylnaphthyl, isopropylnaphthyl, chloronaphthyl, ethoxynaphthyl, 2,6-dimethylphenyl, 2,4,6-trimethylphenyl, 2,6-dimethoxyphenyl, 2,6-dichlorophenyl, 4-bromophenyl, 2- or 4-nitrophenyl, 2,4- or 2,6-dinitrophenyl, 4-dimethylaminophenyl, 4-acetylphenyl, methoxyethylphenyl or ethoxymethylphenyl radical.

If the radicals R⁴ and R⁵ in formula (II) together form a ring, R⁴ and R⁵ are preferably a butyl-1,4-ylene chain or particularly preferably a 1,3-butadien-1,4-ylene chain, which means that the aromatic sulfonic acids in this case preferably have a tetrahydronaphthalene or particularly preferably a naphthalene structure.

The radical R³ is particularly preferably hydrogen, a methyl, ethyl, n-propyl, isopropyl, tert-butyl, cyclopentyl or cyclohexyl radical, especially preferably hydrogen.

The radicals R⁴ and R⁵ are particularly preferably each independently hydrogen, a methyl, ethyl, isopropyl, tert-butyl, hexyl, octyl, nonyl, decyl, dodecyl, phenyl or naphthyl radical, especially preferably hydrogen and/or a methyl group. In this case, preferably one of the radicals R⁴ and R⁵ is hydrogen while the other is other than hydrogen.

The sulfonic acid group in formula (II), as well as the substituents R⁴ and R⁵, is in the para- or meta-position on the aromatic ring based on the primary or secondary amino group, the sulfonic acid group preferably in this case being in the meta-position.

Suitable aromatic aminosulfonic acids of the general formula (II) are, for example, 4-aminotoluene-2-sulfonic acid, 5-aminotoluene-2-sulfonic acid or 2-aminonaphthalene-4-sulfonic acid, particular preference being given to 4-aminotoluene-2-sulfonic acid.

Further starting compounds B) for the process according to the invention are finally also amino-functional sulfonic acids of the general formula (III)

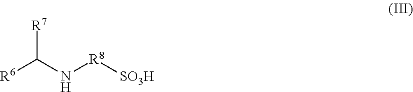

in which R⁶ and R⁷ are each independently identical or different radicals and are hydrogen or saturated or unsaturated, linear or branched, aliphatic or cycloaliphatic or aromatic organic radicals having 1 to 18 carbon atoms, which are substituted or unsubstituted and/or comprise heteroatoms in the chain, wherein R⁶ and R⁷, in combination with each other and optionally with one further nitrogen atom or one oxygen atom, may form cycloaliphatic or heterocyclic rings having 3 to 8 carbon atoms, which may optionally be further substituted, and R⁸ is a linear or branched aliphatic radical having 2 to 6 carbon atoms.

In the general formula (III), R⁶ and R⁷ are each independently preferably saturated, linear or branched, aliphatic or cycloaliphatic organic radicals having 1 to 8 carbon atoms, which may also form cycloaliphatic rings in combination with each other, and R⁸ is a linear or branched aliphatic radical having 2 to 4 carbon atoms.

Suitable aminosulfonic acids of the general formula (III) are, for example, 2-aminoethanesulfonic acid, 3-aminopropane-1-sulfonic acid, 4-aminobutane-1-sulfonic acid, 3-aminobutane-1-sulfonic acid, 3-amino-2-methylpropane-1-sulfonic acid, 4-aminobutane-2-sulfonic acid, 2-methylaminoethane-1-sulfonic acid, 2-ethylaminoethane-1-sulfonic acid, 2-propylaminoethane-1-sulfonic acid, 2-isopropylaminoethane-1-sulfonic acid, 2-n-butylaminoethane-1-sulfonic acid, 2-(tert-butyl)aminoethane-1-sulfonic acid, 2-pentylaminoethane-1-sulfonic acid, 2-hexylaminoethane-1-sulfonic acid, 2-octylaminoethane-1-sulfonic acid, 2-anilinoethane-1-sulfonic acid, 2-cyclopropylaminoethane-1-sulfonic acid, 2-cyclobutylaminoethane-1-sulfonic acid, 2-cyclopentylaminoethane-1-sulfonic acid, 2-cyclohexylaminoethane-1-sulfonic acid, the isomeric 2-(methylcyclohexyl)aminoethane-1-sulfonic acids, 2-(2,3-dimethylcyclohexyl)aminoethane-1-sulfonic acid, 2-(3,3,5-trimethylcyclohexylaminoethane-1-sulfonic acid, 2-(4-tert-butylcyclohexyl)aminoethane-1-sulfonic acid, 2-cycloheptylaminoethane-1-sulfonic acid, 2-cyclooctylaminoethane-1-sulfonic acid, 2-(2-norbornyl)aminoethane-1-sulfonic acid, 2-(1-adamantyl)aminoethane-1-sulfonic acid, 2-(3,5-dimethyl-1-adamantyl)aminoethane-1-sulfonic acid, 3-methylaminopropane-1-sulfonic acid, 3-ethylaminopropane-1-sulfonic acid, 3-propylaminopropane-1-sulfonic acid, 3-isopropylaminopropane-1-sulfonic acid, 3-n-butylaminopropane-1-sulfonic acid, 3-(tert-butyl)aminopropane-1-sulfonic acid, 3-pentylaminopropane-1-sulfonic acid, 3-hexylaminopropane-1-sulfonic acid, 3-octylaminopropane-1-sulfonic acid, 3-anilinopropane-1-sulfonic acid, 3-cyclopropylaminopropane-1-sulfonic acid, 3-cyclobutylaminopropane-1-sulfonic acid, 3-cyclopentylaminopropane-1-sulfonic acid, 3-cyclohexylaminopropane-1-sulfonic acid, the isomeric 3-(methylcyclohexyl)aminopropane-1-sulfonic acids, 3-(2,3-dimethylcyclohexyl)aminopropane-1-sulfonic acid, 3-(3,3,5-trimethylcyclohexylaminopropane-1-sulfonic acid, 3-(4-tert-butylcyclohexyl)aminopropane-1-sulfonic acid, 3-cycloheptylaminopropane-1-sulfonic acid, 3-cyclooctylaminopropane-1-sulfonic acid, 3-(2-norbornyl)aminopropane-1-sulfonic acid, 3-(1-adamantyl)aminopropane-1-sulfonic acid, 3-(3,5-dimethyl-1-adamantyl)aminopropane-1-sulfonic acid, 3-methylaminobutane-1-sulfonic acid, 3-ethylaminobutane-1-sulfonic acid, 3-propylaminobutane-1-sulfonic acid, 3-isopropylaminobutane-1-sulfonic acid, 3-n-butylaminobutane-1-sulfonic acid, 3-(tert-butyl)aminobutane-1-sulfonic acid, 3-pentylaminobutane-1-sulfonic acid, 3-hexylaminobutane-1-sulfonic acid, 3-octylaminobutane-1-sulfonic acid, 3-anilinobutane-1-sulfonic acid, 3-cyclopropylaminobutane-1-sulfonic acid, 3-cyclobutylaminobutane-1-sulfonic acid, 3-cyclopentylaminobutane-1-sulfonic acid, 3-cyclohexylaminobutane-1-sulfonic acid, the isomeric 3-(methylcyclohexyl)aminobutane-1-sulfonic acids, 3-(2,3-dimethylcyclohexyl)aminobutane-1-sulfonic acid, 3-(3,3,5-trimethylcyclohexylaminobutane-1-sulfonic acid, 3-(4-tert-butylcyclohexyl)aminobutane-1-sulfonic acid, 3-cycloheptylaminobutane-1-sulfonic acid, 3-cyclooctylaminobutane-1-sulfonic acid, 3-(2-norbornyl)aminobutane-1-sulfonic acid, 3-(1-adamantyl)aminobutane-1-sulfonic acid, 3-(3,5-dimethyl-1-adamantyl)aminobutane-1-sulfonic acid, 4-methylaminobutane-1-sulfonic acid, 4-ethylaminobutane-1-sulfonic acid, 4-propylaminobutane-1-sulfonic acid, 4-isopropylaminobutane-1-sulfonic acid, 4-n-butylaminobutane-1-sulfonic acid, 4-(tert-butyl)aminobutane-1-sulfonic acid, 4-pentylaminobutane-1-sulfonic acid, 4-hexylaminobutane-1-sulfonic acid, 4-octylaminobutane-1-sulfonic acid, 4-anilinobutane-1-sulfonic acid, 4-cyclopropylaminobutane-1-sulfonic acid, 4-cyclobutylaminobutane-1-sulfonic acid, 4-cyclopentylaminobutane-1-sulfonic acid, 4-cyclohexylaminobutane-1-sulfonic acid, the isomeric 4-(methylcyclohexyl)aminobutane-1-sulfonic acids, 4-(2,3-dimethylcyclohexyl)aminobutane-1-sulfonic acid, 4-(3,3,5-trimethylcyclohexylaminobutane-1-sulfonic acid, 4-(4-tert-butylcyclohexyl)aminobutane-1-sulfonic acid, 4-cycloheptylaminobutane-1-sulfonic acid, 4-cyclooctylaminobutane-1-sulfonic acid, 4-(2-norbornyl)aminobutane-1-sulfonic acid, 4-(1-adamantyl)aminobutane-1-sulfonic acid, 4-(3,5-dimethyl-1-adamantyl)aminobutane-1-sulfonic acid, 3-methylamino-2-methylpropane-1-sulfonic acid, 3-ethylamino-2-methylpropane-1-sulfonic acid, 3-propylamino-2-methylpropane-1-sulfonic acid, 3-isopropylamino-2-methylpropane-1-sulfonic acid, 3-n-butylamino-2-methylpropane-1-sulfonic acid, 3-(tert-butyl)amino-2-methylpropane-1-sulfonic acid, 3-pentylamino-2-methylpropane-1-sulfonic acid, 3-hexylamino-2-methylpropane-1-sulfonic acid, 3-octylamino-2-methylpropane-1-sulfonic acid, 3-anilino-2-methylpropane-1-sulfonic acid, 3-cyclopropylamino-2-methylpropane-1-sulfonic acid, 3-cyclobutylamino-2-methylpropane-1-sulfonic acid, 3-cyclopentylamino-2-methylpropane-1-sulfonic acid, 3-cyclohexylamino-2-methylpropane-1-sulfonic acid, the isomeric 3-(methylcyclohexyl)amino-2-methylpropane-1-sulfonic acids, 3-(2,3-dimethylcyclohexyl)amino-2-methylpropane-1-sulfonic acid, 3-(3,3,5-trimethylcyclohexylamino-2-methylpropane-1-sulfonic acid, 3-(4-tert-butylcyclohexyl)amino-2-methylpropane-1-sulfonic acid, 3-cycloheptylamino-2-methylpropane-1-sulfonic acid, 3-cyclooctylamino-2-methylpropane-1-sulfonic acid, 3-(2-norbornyl)amino-2-methylpropane-1-sulfonic acid, 3-(1-adamantyl)amino-2-methylpropane-1-sulfonic acid, 3-(3,5-dimethyl-1-adamantyl)amino-2-methylpropane-1-sulfonic acid, 3-methylaminobutane-2-sulfonic acid, 3-ethylaminobutane-2-sulfonic acid, 3-propylaminobutane-2-sulfonic acid, 3-isopropylaminobutane-2-sulfonic acid, 3-n-butylaminobutane-2-sulfonic acid, 3-(tert-butyl)aminobutane-2-sulfonic acid, 3-pentylaminobutane-2-sulfonic acid, 3-hexylaminobutane-2-sulfonic acid, 3-octylaminobutane-2-sulfonic acid, 3-anilinobutane-2-sulfonic acid, 3-cyclopropylaminobutane-2-sulfonic acid, 3-cyclobutylaminobutane-2-sulfonic acid, 3-cyclopentylaminobutane-2-sulfonic acid, 3-cyclohexylaminobutane-2-sulfonic acid, the isomeric 3-(methylcyclohexyl)aminobutane-2-sulfonic acids, 3-(2,3-dimethylcyclohexyl)aminobutane-2-sulfonic acid, 3-(3,3,5-trimethylcyclohexylaminobutane-2-sulfonic acid, 3-(4-tert-butylcyclohexyl)aminobutane-2-sulfonic acid, 3-cycloheptylaminobutane-2-sulfonic acid, 3-cyclooctylaminobutane-2-sulfonic acid, 3-(2-norbornyl)aminobutane-2-sulfonic acid, 3-(1-adamantyl)amino-2-sulfonic acid and 3-(3,5-dimethyl-1-adamantyl)aminobutane-2-sulfonic acid.

Particularly preferred aminosulfonic acids B) for the process according to the invention are those of the general formula (III), in which neither of the radicals R⁶ and R⁷ are hydrogen.

Very particularly preferred aminosulfonic acids B) are 2-isopropylaminoethane-1-sulfonic acid, 3-isopropylaminopropane-1-sulfonic acid, 4-isopropylaminobutane-1-sulfonic acid, 2-cyclohexylaminoethane-1-sulfonic acid, 3-cyclohexylaminopropane-1-sulfonic acid and 4-cyclohexylaminobutane-1-sulfonic acid.

In the process according to the invention, the sulfonic acids B) bearing at least one group that is reactive to isocyanate groups are at least partially neutralized before, during or after the reaction with the polyisocyanate component A) and in this manner are converted to sulfonate groups.

Suitable neutralizing agents in this case are any bases, such as alkali metal hydroxides or alkaline earth metal hydroxides, but preferably amines, especially tertiary monoamines such as, for example, trimethylamine, triethylamine, the isomeric tripropyl- and tributylamines, N,N-dimethylethylamine, N,N-dimethylpropylamine, N,N-dimethylisopropylamine, N,N-dimethylbutylamine, N,N-dimethylisobutylamine, N,N-dimethyloctylamine, N,N-dimethyl-2-ethylhexylamine, N,N-dimethyllaurylamine, N,N-diethylmethylamine, N,N-diethylpropylamine, N,N-diethylbutylamine, N,N-diethylhexylamine, N,N-diethyloctylamine, N,N-diethyl-2-ethylhexylamine, N,N-diethyllaurylamine, N,N-diisopropylmethylamine, N,N-diisopropylethylamine, N,N-diisopropylbutylamine, N,N-diisopropyl-2-ethylhexylamine, N,N-dioctylmethylamine, N,N-dimethylallylamine, N,N-dimethylbenzylamine, N,N-diethylbenzylamine, N,N-dibenzylmethylamine, tribenzylamine, N,N-dimethyl-4-methylbenzylamine, N,N-dimethylcyclohexylamine, N,N-diethylcyclohexylamine, N,N-dicyclohexylmethylamine, N,N-dicyclohexylethylamine, tricyclohexylamine, N-methylpyrrolidine, N-ethylpyrrolidine, N-propylpyrrolidine, N-butylpyrrolidine, N-methylpiperidine, N-ethylpiperidine, N-propylpiperidine, N-butylpiperidine, N-methylmorpholine, N-ethylmorpholine, N-propylmorpholine, N-butylmorpholine, N-sec-butylmorpholine, N-tert-butylmorpholine, N-isobutylmorpholine and quinuclidine or tertiary diamines such as, for example, 1,3-bis(dimethylamino)propane, 1,4-bis(dimethylamino)butane and N,N′-dimethylpiperazine, or any mixtures of such tertiary amines.

Suitable but less preferred neutralizing amines are also additionally tertiary amines bearing groups that are reactive to isocyanate groups, for example alkanolamines such as dimethylethanolamine, methyldiethanolamine or triethanolamine.

Preferred neutralizing amines for the sulfonic acids B) are N,N-dimethylbutylamine, N,N-dimethyl-2-ethylhexylamine, N,N-diethylmethylamine, N,N-diisopropylethylamine, N,N-diisopropyl-2-ethylhexylamine, N,N-dimethylcyclohexylamine, N,N-dicyclohexylmethylamine, N-methylpyrrolidine, N-methylpiperidine, N-ethylpiperidine, N-methylmorpholine, N-ethylmorpholine, N-isobutylmorpholine or mixtures thereof.

Particular preference is given to N,N-dimethylbutylamine, N,N-diethylmethylamine, N,N-diisopropylethylamine, N,N-dimethylcyclohexylamine, N-methylpiperidine, N-ethylmorpholine or mixtures thereof.

The neutralizing agents specified in the process according to the invention are added in such amounts that the sulfonic acid groups of the starting compounds B) in the resulting process products according to the invention are neutralized to an extent of at least 20 mol %, preferably to an extent of at least 50 mol %, particularly preferably to an extent of at least 90 mol % and especially preferably completely neutralized and are present in the form of sulfonate groups.

Starting compounds C) for the process according to the invention are any non-ionic hydrophilic or hydrophobic organic compounds which comprise at least one group that is reactive to isocyanates. The compounds C) are different to B). In other words, the starting component C) comprises at least one non-ionic hydrophilic organic compound having at least one group reactive to isocyanates and/or at least one hydrophobic organic compound having at least one group reactive to isocyanates.

Suitable non-ionic hydrophilic organic compounds C) are, for example, monohydric or polyhydric polyalkylene oxide polyether alcohols having a statistical average of 5 to 50 ethylene oxide units per molecule, as obtainable in a manner known per se by alkoxylation of suitable starter molecules (for example see Ullmanns Encyclopädie der technischen Chemie, 4th edition, volume 19, Verlag Chemie, Weinheim pp. 31-38). Starter molecules of this kind may be, for example, any mono- or polyhydric alcohols of the molecular weight range 32 to 300, such as methanol, ethanol, n-propanol, isopropanol, n-butanol, isobutanol, sec-butanol, the isomeric pentanols, hexanols, octanols and nonanols, n-decanol, n-dodecanol, n-tetradecanol, n-hexadecanol, n-octadecanol, cyclohexanol, the isomeric methylcyclohexanols, hydroxymethylcyclohexane, 3-methyl-3-hydroxymethyloxetane, benzyl alcohol, phenol, the isomeric cresols, octylphenols, nonylphenols and naphthols, furfuryl alcohol, tetrahydrofurfuryl alcohol, 1,2-ethanediol, 1,2- and 1,3-propanediol, the isomeric butanediols, pentanediols, hexanediols, heptanediols and octanediols, 1,2- and 1,4-cyclohexanediol, 1,4-cyclohexanedimethanol, 4,4′-(1-methylethylidene)biscyclohexanol, 1,2,3-propanetriol, 1,1,1-trimethylolethane, 1,2,6-hexanetriol, 1,1,1-trimethylolpropane, 2,2-bis(hydroxymethyl)-1,3-propanediol or 1,3,5-tris(2-hydroxyethyl)isocyanurate.

Alkylene oxides suitable for the alkoxylation reaction are especially ethylene oxide and propylene oxide, which can be used in the alkoxylation reaction in any sequence or else in a mixture. Suitable polyether alcohols are either pure polyethylene oxide polyether alcohols or mixed polyalkylene oxide polyethers, the alkylene oxide units of which consist to an extent of at least 70 mol %, preferably to an extent of at least 80 mol %, of ethylene oxide units.

Preferred polyalkylene oxide polyether alcohols C) are those which have been produced using the aforementioned monoalcohols of the molecular weight range 32 to 150 as starter molecules. Particularly preferred polyether alcohols are pure polyethylene glycol monomethyl ether alcohols having a statistical average of 5 to 50, especially preferably 5 to 25 ethylene oxide units.

Non-ionic hydrophilic organic compounds C) in the process according to the invention are used, if at all, in amounts to an extent of up to 30% by weight, preferably up to 25% by weight, particularly preferably up to 20% by weight, based on the starting polyisocyanate A).

Suitable hydrophobic organic compounds C) are, for example, aliphatic alcohols or fatty acid ester alcohols having in each case at least 8 carbon atoms.

Suitable aliphatic hydrophobic alcohols are, for example, 1-octanol, 2-ethyl-1-hexanol, the isomeric nonanols, decanols, undecanols, dodecanols, tridecanols, tetradecanols, pentadecanols, hexadecanols and 3-phenyl-2-propenol (cinnamyl alcohol) and also hydrophobic polyalkylene oxide alcohols started by these alcohols, the alkylene oxide units of which consist to an extent of at least 80 mol %, preferably at least 90 mol %, particularly preferably exclusively of propylene oxide units.

Suitable fatty acid ester alcohols C) are, for example, esterification products of hydroxy-functional fatty acids, such as hydroxyacetic acid, 3-hydroxypropionic acid, 3- and 4-hydroxybutyric acid, 2-hydroxysuccinic acid (malic acid), 2,3-dihydroxysuccinic acid (tartaric acid), 2-hydroxy-1,2,3-propanetricarboxylic acid (citric acid), hydroxystearic acid, ricinoleic acid, salicylic acid and mandelic acid, with alcohols such as methanol, ethanol, n-propanol, isopropanol, n-butanol, isobutanol, sec-butanol, the isomeric pentanols, hexanols, octanols and nonanols, n-decanol or n-dodecanol, in which the sum total of carbon atoms of the fatty acid and esterification alcohol is at least 8.

Hydrophobic organic compounds C) in the process according to the invention are used, if at all, in amounts to an extent of up to 30% by weight, preferably up to 20% by weight, particularly preferably up to 10% by weight, based on the starting polyisocyanate A).

In accordance with the invention, the reaction of the polyisocyanate component A) with the organic compound B) containing sulfonic acid or sulfonate groups takes place in the presence of at least one radical scavenger and/or peroxide decomposer D).

Suitable radical scavengers and/or peroxide decomposers D) are any organic compounds known per se which are used in paint or coating technology for preventing undesired oxidative ageing processes induced, for example, by the effect of oxygen. Suitable radical scavengers and/or peroxide decomposers customary in the paint industry are, for example, phenols, thioethers and/or di- or trisubstituted phosphites.

Suitable phenols D) are particularly sterically hindered phenols such as e.g. 2,6-di-tert-butylphenol, 2,4-dimethyl-6-tert-butylphenol, 2,6-di-tert-butyl-4-methylphenol, triethylene glycol bis(3-tert-butyl-4-hydroxy-5-methylphenyl)propionate, octadecyl 3-(3,5-di-tert-butyl-4-hydroxyphenyl)propionate, pentaerythritol tetrakis(3-(3,5-di-tert-butyl-4-hydroxyphenyl)propionate), esters of 3-(3,5-di-tert-butyl-4-hydroxyphenyl)propionic acid with aliphatic branched C7- to C9-alcohols, such as e.g. isoheptyl 3-(3,5-di-tert-butyl-4-hydroxyphenyl)propionate, isooctyl 3-(3,5-di-tert-butyl-4-hydroxyphenyl)propionate or isononyl 3-(3,5-di-tert-butyl-4-hydroxyphenyl)propionate, isotridecyl 3-(3,5-di-tert-butyl-4-hydroxyphenyl)propionate, thiodiethyl bis[3-(3,5-di-tert-butyl-4-hydroxyphenyl)propionate], N,N′-hexamethylenebis(3,5-di-tert-butyl-4-hydroxyphenyl)propionamide, 1,2-bis(3,5-di-tert-butyl-4-hydroxyphenylpropionic acid) hydrazide, 2,4-di-tert-butylphenyl 4′-hydroxy-3′,5′-di-tert-butylbenzoate, esters of (3,5-di-tert-butyl-4-hydroxyphenyl)methylthioacetic acid with aliphatic branched C10- to C14-alcohols, 2,2′-thiobis(4-methyl-6-tert-butylphenol), 2-methyl-4,6-bis(octylthiomethyl)phenol, 1,3,5-trimethyl-2,4,6-tris(3,5-di-tert-butyl-4-hydroxybenzyl)benzene, tris(3,5-di-tert-butyl-4-hydroxybenzyl) isocyanurate or 2,5-di-tert-amylhydroquinone.

Suitable thioethers D) are, for example, didodecyl 3,3′-thiodipropionate or dioctadecyl 3,3′-thiodipropionate, which are preferably used in combination with phenolic radical scavengers and/or peroxide decomposeres of the type specified.

Suitable phosphites D) are, for example, di- or preferably trisubstituted phosphites such as dibutyl phosphite and dibenzyl phosphite, triethyl phosphite and tributyl phosphite. The radical scavengers and/or peroxide decomposers D) of the phosphite type are preferably trisubstituted phosphites in which at least one of the substituents is an optionally substituted aromatic radical having 6 to 18 carbon atoms or a linear or branched aliphatic radical having 9 to 18 carbon atoms, for example aryl phosphites such as triphenyl phosphite, tris(2,4-di-tert-butylphenyl) phosphite or tris(nonylphenyl) phosphite, alkyl-aryl phosphites such as diphenylisooctyl phosphite, diphenylisodecyl phosphite, diisodecylphenyl phosphite, diisooctylphenyl phosphite, phenyl neopentyl glycol phosphite or 2,4,6-tri-tert-butylphenyl(2-butyl-2-ethyl-1,3-propanediol) phosphite, alkyl phosphites such as triisodecyl phosphite, trilauryl phosphite or tris(tridecyl) phosphite, or aromatic or aliphatic substituted diphosphites such as diisodecyl pentaerythritol diphosphite, distearyl pentaerythritol diphosphite, bis(2,4-di-tert-butylphenyl) pentaerythritol diphosphite or tetraphenyl dipropylene glycol diphosphite.

Preferred radical scavengers and/or peroxide decomposers D) for the process according to the invention are phenolic compounds of the type specified, particularly preferably sterically hindered phenols comprising 2,6-di-tert-butyl-4-methylphenol structures. Particularly preferred radical scavengers and/or peroxide decomposers D) are 2,6-di-tert-butyl-4-methylphenol, esters of 3-(3,5-di-tert-butyl-4-hydroxyphenyl)propionic acid with aliphatic, branched C7- to C9-alcohols, octadecyl 3-(3,5-di-tert-butyl-4-hydroxyphenyl)propionate and/or thiodiethyl bis(3-(3,5-di-tert-butyl-4-hydroxyphenyl)propionate).

The radical scavengers and/or peroxide decompsers D) can be used in the process according to the invention both singly and in any combinations with one another in amounts from 0.001 to 3.0% by weight, preferably 0.002 to 2.0% by weight, particularly preferably from 0.005 to 1.0% by weight, especially preferably from 0.01 to 0.5% by weight, calculated as the total amount of radical scavengers and/or peroxide decomposers used, based on the amount of starting polyisocyanate A).

To carry out the process according to the invention, the starting components A), B) and optionally C) are reacted with one another in the presence of a radical scavenger and/or peroxide decomposer D) at temperatures of 40 to 150° C., preferably 50 to 130° C., particularly preferably 70 to 110° C., maintaining an equivalent ratio of NCO groups to groups reactive to NCO groups of from 2:1 to 400:1, preferably from 4:1 to 250:1, preferably until the theoretically calculated NCO content is achieved, wherein the reaction course can be monitored by, for example, titrimetric determination of the NCO content. The NCO content is determined by preferably titrimetric means in accordance with DIN EN ISO 11909:2007-05.

The radical scavengers and/or peroxide decomposers D) essential to the invention can already be mixed in this case in the amounts specified above with one or more of the reaction partners, the polyisocyanate component A), the compound reactive to isocyanate groups having sulfonic acid or sulfonate groups B) and/or the optionally concomitantly used non-ionic hydrophilic or hydrophobic organic compounds C), prior to the start of the actual reaction. However, the radical scavengers and/or peroxide decomposers can also be added to the reaction mixture at any desired time point during the metered addition of the reaction partners or thereafter, preferably at the start of the metered addition.

When using sulfonic acids B) reactive to isocyanate groups, these are at least partially neutralized in the process according to the invention by adding a neutralizing agent of the aforementioned type in the aforementioned amount, as described above, before, during or after the reaction with the polyisocyanate component A) and converted into sulfonate groups. In the event that the neutralization is effected before or during the reaction, it is also possible to mix the radical scavenger and/or peroxide decomposer D) with the neutralizing agent, preferably a tertiary amine of the aforementioned type.

The radical scavenger and/or peroxide decomposer D) is preferably added prior to the start of the reaction of the polyisocyanate component A).

The reaction of component A) with B) and optionally C) generally proceeds sufficiently rapidly, but known catalysts customary in polyurethane chemistry may optionally also be used in the process according to the invention to accelerate the reaction, for example further tertiary amines such as triethylamine, pyridine, methylpyridine, benzyldimethylamine, N,N-endoethylene piperazine, N-methylpiperidine, pentamethyldiethylenetriamine, N,N-dimethylaminocyclohexane, N,N′-dimethylpiperazine or metal salts such as iron(III) chloride, aluminium tri(ethylacetoacetate), zinc chloride, zinc(II) n-octanoate, zinc(II) 2-ethyl-1-hexanoate, zinc(II) 2-ethylcaproate, zinc(II) stearate, zinc(II) naphthenate, zinc(II) acetylacetonate, tin(II) n-octanoate, tin(II) 2-ethyl-1-hexanoate, tin(II) ethylcaproate, tin(II) laurate, tin(II) palmitate, dibutyltin(IV) oxide, dibutyltin(IV) dichloride, dibutyltin(IV) diacetate, dibutyltin(IV) dimaleate, dibutyltin(IV) dilaurate, dioctyltin(IV) diacetate, molybdenum glycolate or any of such catalysts.

These catalysts F) are used in the process according to the invention, if at all, in an amount of 0.001 to 2% by weight, preferably 0.005 to 0.5% by weight, based on the total weight of the reaction partners.

The process of the invention is preferably conducted without solvent. If desired, however, suitable solvents inert to the reactive groups of the starting components, in particular to isocyanate groups, can also be used. Examples of suitable solvents are the customary paint solvents which are known per se, such as, e.g. ethyl acetate, butyl acetate, ethylene glycol monomethyl or monoethyl ether acetate, 1-methoxy-2-propyl acetate, 3-methoxy-n-butyl acetate, acetone, 2-butanone, 4-methyl-2-pentanone, cyclohexanone, toluene, xylene, chlorobenzene, white spirit, relatively highly substituted aromatics, of the kind commercialized, for example, under the names solvent naphtha, SOLVESSO, ISOPAR, NAPPAR (Deutsche EXXON CHEMICAL GmbH, Cologne, DE) and SHELLSOL (Deutsche Shell Chemie GmbH, Eschborn, DE), carbonic esters such as dimethyl carbonate, diethyl carbonate, 1,2-ethylene carbonate and 1,2-propylene carbonate, lactones such as β-propiolactone, γ-butyrolactone, ε-caprolactone and ε-methylcaprolactone, and also solvents such as propylene glycol diacetate, diethylene glycol dimethyl ether, dipropylene glycol dimethyl ether, butyl glycol acetate, butyl diglycol acetate, 1,3-dioxolane, N-methylpyrrolidone and N-methylcaprolactam, or any mixtures of such solvents.

Polyisocyanates containing sulfonate groups are obtained as process products, which are characterized by higher isocyanate contents, lower colour numbers and especially lower viscosities and better emulsifiability in direct comparison with polyisocyanates containing sulfonate groups analogously formed, such as were obtained by the production processes currently known from the prior art without concomitant use of radical scavengers and/or peroxide decomposers. They can generally be readily converted into sedimentation-stable dispersions without using high shear forces by merely stirring into water.

The features specified as preferred for the process according to the invention are also preferred for the further subject matters of the invention.

The present invention therefore further relates to polyisocyanates containing sulfonate groups, obtainable or obtained by the process according to the invention. In addition to the aforementioned differences, chemical reaction with the isocyanate groups may also occur depending on the radical scavenger and/or peroxide decomposer D) used. Therefore, when using phenolic compounds mentioned above as radical scavengers and/or peroxide decomposers D) for example, the invention further relates to a polyisocyanate containing sulfonate groups, characterized in that it comprises one or more urethane groups, preferably from 0.005 to 0.9% by weight of urethane groups (calculated as —NHCOO—; molelcular weight=59 g/mol) which are bonded to a phenolic radical.

Optionally, any further non-hydrophilized polyisocyanates, for example those of the type mentioned as suitable starting polyisocyanates A), may be added to the polyisocyanates containing sulfonate groups according to the invention, whereby polyisocyanate mixtures are obtained which likewise represent polyisocyanate mixtures according to the invention, since these generally consist of mixtures of
(i) polyisocyanates modified hydrophilically with sulfonate groups in accordance with the invention and
(ii) unmodified polyisocyanates of the type mentioned by way of example.

In such mixtures, the polyisocyanates containing sulfonate groups according to the invention take on the function of an emulsifier for the proportion of non-hydrophilic polyisocyanates that are subsequently mixed in.

The polyisocyanate mixtures according to the invention represent valuable starting materials for the production of polyurethane plastics by the isocyanate polyaddition process. For this purpose, the polyisocyanate mixtures are preferably used in the form of aqueous emulsions which can be reacted in combination with polyhydroxyl compounds dispersed in water in the context of aqueous two-component systems.

The present invention further relates to the use of one or more radical scavengers and/or peroxide decomposers D), preferably one or more sterically hindered phenols comprising 2,6-di-tert-butyl-4-methylphenol structures, for improving the incorporability of polyisocyanates containing sulfonate groups in aqueous systems.

The polyisocyanate mixtures comprising sulfonate groups according to the invention are particularly preferably used as crosslinkers for paint binders or paint binder components, dissolved or dispersed in water, that have groups reactive to isocyanate groups, especially alcoholic hydroxyl groups, in the production of coatings using aqueous coating compositions based on such binders or binder components. The crosslinker, optionally in emulsified form, can be combined with the binders or binder components here by simple stirring by any methods prior to processing the coating compositions or even by using two-component spray guns.

Paint binders or paint binder components which may be mentioned in this context include: polyacrylates comprising hydroxyl groups, dissolved or dispersed in water, especially those of the molecular weight range 1000 to 20 000, which are valuable two-component binders with organic polyisocyanates as crosslinkers, or optionally urethane-modified polyester resins comprising hydroxyl groups, dispersed in water, of the type known from polyester and alkyd resin chemistry. In principle, suitable as reaction partners for the polyisocyanate mixtures according to the invention are any binders, dissolved or dispersed in water, comprising groups that are reactive to isocyanates. These also include, for example, polyurethanes or polyureas dispersed in water, which can be crosslinked with polyisocyanates due to the active hydrogen atoms present in the urethane or urea groups.

The present invention further relates to a coating composition comprising at least one polyisocyanate containing sulfonate groups according to the invention.

In the case of use according to the invention as crosslinker component for aqueous paint binders, the polyisocyanate mixtures comprising sulfonate groups according to the invention are generally used in such amounts that correspond to an equivalents ratio of NCO groups to groups that are reactive to NCO groups, especially alcoholic hydroxyl groups, from 0.5:1 to 2:1.

The polyisocyanate mixtures according to the invention may optionally be admixed in minor amounts, however, with non-functional aqueous paint binders, for the purpose of achieving very specific properties, as an additive for improving adhesion, for example.

The polyisocyanate mixtures according to the invention can of course also be used in a form in which they are blocked with blocking agents known per se from polyurethane chemistry, in combination with the aforementioned aqueous paint binders or paint binder components, as aqueous one-component PUR baking systems. Suitable blocking agents are, for example, diethyl malonate, ethyl acetoacetate, acetone oxime, butanone oxime, ε-caprolactam, 3,5-dimethylpyrazole, 1,2,4-triazole, dimethyl-1,2,4-triazole, imidazole or mixtures of any of these blocking agents.

Substrates contemplated for the aqueous coatings formulated using the inventive polyisocyanate mixtures comprising sulfonate groups include any desired substrates, such as, for example, metal, wood, glass, stone, ceramic materials, concrete, rigid and flexible plastics, textiles, leather, and paper, which prior to coating may optionally also be provided with customary primers.

In general, the aqueous coating compositions formulated with the polyisocyanate mixtures according to the invention, into which compositions, optionally, the auxiliaries and additives customary in the coatings sector may be incorporated, examples being flow control assistants, dyes, colour pigments, fillers, matting agents or emulsifiers, have technical coatings properties that are good even in the case of room-temperature drying.

Of course, they may alternatively be dried under forced conditions at elevated temperature or by baking at temperatures up to 260° C.

The present invention further provides a substrate coated with a coating composition according to the invention optionally cured by the action of heat.

On account of their excellent water emulisfiability, which enables a homogeneous, particularly finely divided distribution in aqueous paint binders, the use of the polyisocyanate mixtures according to the invention as crosslinker component for aqueous polyurethane coatings results in coatings with outstanding optical properties, especially high surface gloss, flow and high transparency.

In addition to the preferred use as crosslinker components for aqueous 2K-PUR coatings, the polyisocyanate mixtures comprising sulfonate groups according to the invention are outstandingly suitable as crosslinkers for aqueous dispersion adhesives, leather and textile coatings or textile printing pastes, as AOX-free paper auxiliaries or even as additives for mineral building materials, for example concrete or mortar.

The features specified as preferred for the process according to the invention are also preferred for the further subject matters of the invention.

The examples which follow serve to illustrate the present invention, but should in no way be understood as imposing any restriction on the scope of protection.

### EXAMPLES

All percentages are based on weight unless otherwise stated.

The NCO contents were determined by titrimetry according to DIN EN ISO 11909:2007-05.

All viscosity measurements were recorded with a PHYSICA MCR 51 rheometer from Anton Paar Germany GmbH (DE) according to DIN EN ISO 3219:1994-10 at a shear rate of 250 s-1.

The residual monomer contents were measured according to DIN EN ISO 10283:2007-11 by gas chromatography with an internal standard.

Water contents were determined by volumetric titration by Karl Fischer in accordance with DIN 53715 (created based on DIN 51777 Part 1 (1973 edition)) using a TITRANDO 841 automatic titration unit from Methrom. The measurement range of this method is from 0.01 to 99% by weight.

The median particle sizes (MPS) of 25% aqueous emulsions serve as a measure of the emulsifiability of the hydrophilic polyisocyanates. For this purpose, 25 g of the inventive polyisocyanate mixture in each case were added to 75 g of deionized water in an Erlenmeyer flask, corresponding to a solids content of 25% by weight in each case, and then the mixtures were each stirred for 1 min at 900 rpm with the aid of a magnetic stirrer. The median particle sizes [nm] of the aqueous emulsions obtained in this manner were then determined using a DTS 5100 type ZETASIZER from Malvern Instruments GmbH (DE). The smaller the median particle size, the finer the distribution of a crosslinker in the aqueous phase (paint binder) and the clearer and more brilliant the coating films obtained.

The Hazen color number was measured by spectrophotometry according to DIN EN ISO 6271-2:2005-03 with a LICO 400 spectrophotometer from Lange, Germany.

### Starting Compounds

### Polyisocyanates A)

### Starting Polyisocyanate A1)

HDI polyisocyanate comprising isocyanurate groups, produced by catalytic trimerization of HDI based on Example 11 of EP-A 330 966, with the modification that the reaction was stopped by addition of dibutyl phosphate at an NCO content of the crude mixture of 40%. Subsequently, unconverted HDI was removed by thin-film distillation at a temperature of 130° C. and a pressure of 0.2 mbar.
NCO content: 21.7%
NCO functionality: 3.4
Monomeric HDI: 0.1%
Viscosity (23° C.): 3080 mPas
Color number (Hazen): 18

### Starting Polyisocyanate A2)

HDI polyisocyanate containing isocyanurate and iminooxadiazinedione groups, prepared in accordance with Example 4 of EP-A 0 962 455, by trimerization of HDI using a 50% solution of tetrabutylphosphonium hydrogendifluoride in isopropanol/methanol (2:1) as catalyst. The reaction was stopped at an NCO content of the crude mixture of 43% by addition of dibutyl phosphate. Subsequently, unconverted HDI was removed by thin-film distillation at a temperature of 130° C. and a pressure of 0.2 mbar.
NCO content: 23.4%
NCO functionality: 3.2
Monomeric HDI: 0.2%
Viscosity (23° C.): 700 mPas
Color number (Hazen): 14

### Starting Polyisocyanate A3)

IPDI polyisocyanate containing isocyanurate groups, prepared by catalytically trimerizing IPDI according to example 2 of EP-A-0 003 765. The reaction was deactivated at an NCO content of the crude mixture of 30.1% by addition of an equimolar amount of dibutyl phosphate, based on the amount of catalyst used, and further stirring for 30 minutes at 80° C. Unconverted IPDI was then removed by thin-film distillation at a temperature of 170° C. and a pressure of 0.3 mbar and the resulting solid resin was diluted with butyl acetate to a solids content of 70%.
NCO content: 11.9%
NCO functionality: 3.3
Monomeric IPDI: 0.28%
Viscosity (23° C.): 620 mPas
Color number (Hazen): 14

### Starting Polyisocyanate A4)

PDI polyisocyanate comprising isocyanurate groups, produced by catalytic trimerization of PDI by the method described in WO 2016/146579 for the polyisocyanate component A2). The reaction was deactivated at an NCO content of the crude mixture of 36.7% by addition of an equimolar amount of dibutyl phosphate, based on the amount of catalyst used, and further stirring for 30 minutes at 80° C. Subsequently, unconverted PDI was removed by thin-film distillation at a temperature of 140° C. and a pressure of 0.5 mbar.
NCO content: 21.8%
NCO functionality: 3.5
Monomeric PDI: 0.09%
Viscosity (23° C.): 9850 mPas
Color number (Hazen): 34

### Aminosulfonic Acids B)

CAPS: 3-(cyclohexylamino)propanesulfonic acid (Sigma-Aldrich Chemie Gmbh, Munich, DE), water content as supplied: 1.7%
CABS: 4-(cyclohexylamino)butanesulfonic acid (Santa Cruz Biotechnology, Inc., Heidelberg, DE), water content as supplied: 4.5%

Both aminosulfonic acids were each dried at 100° C. under vacuum (ca. 0.5 mbar) for 4 hours. In the examples, CAPS was used with a water content of 0.15% and CABS with a water content of 0.30%.

Radical Scavenger and/or Peroxide Decomposer D)

### Radical Scavenger/Peroxide Decomposer D1

2,6-di-tert-butyl-4-methylphenol (Merck Schuchardt OHG, Hohenbrunn, DE)

### Radical Scavenger/Peroxide Decomposer D2

3-(3,5-di-tert-butyl-4-hydroxyphenyl)propionic acid esters with aliphatic branched C₇- to C₉-monoalcohols (IRGANOX 1135, BASF SE, Ludwigshafen, DE)

### Radical Scavenger/Peroxide Decomposer D3

3-(3,5-di-tert-butyl-4-hydroxyphenyl)propionic acid octadecyl ester (IRGANOX 1076, BASF SE, Ludwigshafen, DE)

### Radical Scavenger/Peroxide Decomposer D4

thiodiethyl bis(3-(3,5-di-tert-butyl-4-hydroxyphenyl)propionate) (IRGANOX 1035, BASF SE, Ludwigshafen, DE)

### Example 1 (Non-Inventive)

957.3 g (4.95 val) of the isocyanurate group-containing starting polyisocyanate A1) were stirred together with 27.1 g (0.12 val) of 3-(cyclohexylamino)propanesulfonic acid (CAPS) and 15.6 g (0.12 mol) of dimethylcyclohexylamine at 100° C. for 6 hours under dry nitrogen. After cooling to room temperature, a largely clear polyisocyanate mixture containing sulfonate groups was present. After filtration over a T 5500 filter layer (Seitz), the following characteristic data were determined:
NCO content: 20.0%
NCO functionality: 3.3
Viscosity (23° C.): 7410 mPas
Color number (Hazen): 65
Emulsifiability (MPS): 468 nm

### Example 2 (Inventive)

To 957.3 g (4.95 val) of the isocyanurate group-containing starting polyisocyanate A1) were added 0.2 g (200 ppm) of radical scavenger/peroxide decomposer D1) and the mixture was then stirred together with 27.1 g (0.12 val) of 3-(cyclohexylamino)propanesulfonic acid (CAPS) and 15.6 g (0.12 mol) of dimethylcyclohexylamine at 100° C. for 6 hours under dry nitrogen. After cooling to room temperature, a largely clear polyisocyanate mixture containing sulfonate groups was present. After filtration over a T 5500 filter layer (Seitz), the following characteristic data were determined:
NCO content: 20.2%
NCO functionality: 3.3
Viscosity (23° C.): 6840 mPas
Color number (Hazen): 14
Emulsifiability (MPS): 223 nm

The comparison of examples 1 (non-inventive) and 2 (inventive) shows that the inventive hydrophilic polyisocyanate produced in the presence of a radical scavenger/peroxide decomposer at otherwise identical product composition has a higher NCO content, a lower viscosity and colour number and also better emulsifiability.

### Example 3 to 16 (Inventive and Comparative)

Different polyisocyanates A) were reacted with aminosulfonic acids B) in the presence and absence (respective comparison) of different radical scavengers/peroxide decomposers D) according to the process described in example 2. Table 1 below shows the composition of the reaction mixtures in parts by weight, the amount of radical scavenger/peroxide decomposer used in ppm based on the respective total amount and also the characteristic data of the products obtained.

TABLE 1

| Example | | 3 | 4 | 5 | 6 | 7 | 8 | 9 Comparative | 10 |
|---|---|---|---|---|---|---|---|---|---|
| Starting polyisocyanate A1) | [parts by weight] | 957.3 | 957.3 | 957.3 | 957.3 | 957.3 | 957.3 | 956.2 | 956.2 |
| Starting polyisocyanate A2) | [parts by weight] | — | — | — | — | — | — | — | — |
| Starting polyisocyanate A3) | [parts by weight] | — | — | — | — | — | — | — | — |
| Starting polyisocyanate A4) | [parts by weight] | — | — | — | — | — | — | — | — |
| CAPS | [parts by weight] | 27.1 | 27.1 | 27.1 | 27.1 | 27.1 | 27.1 | — | — |
| CABS | [parts by weight] | — | — | — | — | — | — | 28.2 | 28.2 |
| Dimethylcyclohexylamine | [parts by weight] | 15.6 | 15.6 | 15.6 | 15.6 | 15.6 | 15.6 | 15.6 | 15.6 |
| MPEG 500 | [parts by weight] | — | — | — | — | — | — | — | — |
| Butyl acetate | [parts by weight] | — | — | — | — | — | — | — | — |
| Propylene glycol diacetate | [parts by weight] | — | — | — | — | — | — | — | — |
| Radical scavenger/peroxide | [ppm] | 10 | 50 | 1000 | — | — | — | — | 50 |
| decomposer D1 | | | | | | | | | |
| Radical scavenger/peroxide | [ppm] | — | — | — | 200 | — | — | — | — |
| decomposer D2 | | | | | | | | | |
| Radical scavenger/peroxide | [ppm] | — | — | — | — | 200 | — | — | — |
| decomposer D3 | | | | | | | | | |
| Radical scavenger/peroxide | [ppm] | — | — | — | — | — | 200 | — | — |
| decomposer D4 | | | | | | | | | |
| NCO content: | [%] | 20.1 | 20.1 | 20.2 | 20.2 | 20.3 | 20.0 | 19.9 | 20.1 |
| NCO functionality: | calculated | 3.3 | 3.3 | 3.3 | 3.3 | 3.3 | 3.3 | 3.3 | 3.3 |
| Viscosity (23° C.): | [mPas] | 6880 | 6850 | 6920 | 6870 | 6870 | 6850 | 7320 | 6800 |
| Solids content | [%] | 100 | 100 | 100 | 100 | 100 | 100 | 100 | 100 |
| Colour number (Hazen): | | 20 | 18 | 14 | 21 | 17 | 23 | 69 | 26 |
| Emulsifiability (MPS): | [nm] | 227 | 228 | 226 | 211 | 215 | 220 | 359 | 173 |

| Example | | 11 Comparative | 12 | 13 Comparative | 14 | 15 Comparative | 16 |
|---|---|---|---|---|---|---|---|
| Starting polyisocyanate A1) | [parts by weight] | — | — | — | — | — | — |
| Starting polyisocyanate A2) | [parts by weight] | 947.9 | 947.9 | — | — | — | — |
| Starting polyisocyanate A3) | [parts by weight] | — | — | 911.1 | 911.1 | — | — |
| Starting polyisocyanate A4) | [parts by weight] | — | — | — | — | 858.0 | 858.0 |
| CAPS | [parts by weight] | 33.2 | 33.2 | 19.2 | 19.2 | 26.7 | 26.7 |
| CABS | [parts by weight] | — | — | — | — | — | — |
| Dimethylcyclohexylamine | [parts by weight] | 18.9 | 18.9 | 11.0 | 11.0 | 15.3 | 15.3 |
| MPEG 500 | [parts by weight] | — | — | 32.0 | 32.0 | — | — |
| Butyl acetate | [parts by weight] | — | — | 26.7 | 26.7 | — | — |
| Propylene glycol diacetate | [parts by weight] | — | — | — | — | 100.0 | 100.0 |
| Radical scavenger/peroxide | [ppm] | — | — | — | 200 | — | 200 |
| decomposer D1 | | | | | | | |
| Radical scavenger/peroxide | [ppm] | — | 200 | — | — | — | — |
| decomposer D2 | | | | | | | |
| Radical scavenger/peroxide | [ppm] | — | — | — | — | — | — |
| decomposer D3 | | | | | | | |
| Radical scavenger/peroxide | [ppm] | — | — | — | — | — | — |
| decomposer D4 | | | | | | | |
| NCO content: | [%] | 21.3 | 21.5 | 10.0 | 10.2 | 18.0 | 18.2 |
| NCO functionality: | calculated | 3.1 | 3.1 | 3.1 | 3.1 | 3.4 | 3.4 |
| Viscosity (23° C.): | [mPas] | 1820 | 1570 | 6890 | 5880 | 6900 | 5040 |
| Solids content | [%] | 100 | 100 | 70 | 70 | 90 | 90 |
| Color number (Hazen): | | 55 | 16 | 32 | 16 | 36 | 21 |
| Emulsifiability (MPS): | [nm] | 212 | 134 | 312 | 275 | 354 | 193 |

This specification has been written with reference to various non-limiting and non-exhaustive embodiments. However, it will be recognized by persons having ordinary skill in the art that various substitutions, modifications, or combinations of any of the disclosed embodiments (or portions thereof) may be made within the scope of this specification. Thus, it is contemplated and understood that this specification supports additional embodiments not expressly set forth herein. Such embodiments may be obtained, for example, by combining, modifying, or reorganizing any of the disclosed steps, components, elements, features, aspects, characteristics, limitations, and the like, of the various non-limiting embodiments described in this specification. In this manner, Applicant reserves the right to amend the claims during prosecution to add features as variously described in this specification, and such amendments comply with the requirements of 35 U.S.C. § 112(a), and 35 U.S.C. § 132(a).
Various aspects of the subject matter described herein are set out in the following numbered clauses:

Clause 1. Process for producing polyisocyanates containing sulfonate groups, comprising a reaction of

A) at least one polyisocyanate component having aliphatically, cycloaliphatically, araliphatically and/or aromatically bonded isocyanate groups with

B) at least one organic compound bearing at least one group reactive to isocyanate groups, which comprises one or more sulfonic acid and/or sulfonate groups, wherein the sulfonic acid groups are neutralized at least partially during and/or subsequent to the reaction of A) with B), and optionally

C) further non-ionic hydrophilic or hydrophobic organic compound having at least one group reactive to isocyanates,

characterized in that,

the reaction of the polyisocyanate component A) with the organic compound B) is carried out in the presence of at least one radical scavenger and/or peroxide decomposer D) and wherein the organic compound bearing at least one group reactive to isocyanate groups having sulfonic acid or sulfonate groups B) are hydroxy-, mercapto- and/or amino-functional sulfonic acids and/or salts thereof.

Clause 2. Process according to Clause 1, characterized in that the polyisocyanate component

A) are polyisocyanates having a uretdione, isocyanurate, allophanate, biuret, iminooxadiazinedione and/or oxadiazinetrione structure having exclusively aliphatically and/or cycloaliphatically bonded isocyanate groups.

Clause 3. Process according to one of Clauses 1 and 2, characterized in that the organic compound bearing at least one group reactive to isocyanate groups having sulfonic acid or sulfonate groups B) are 2-hydroxyethanesulfonic acid, 3-hydroxypropanesulfonic acid, 4-hydroxybenzenesulfonic acid, 2-(hydroxymethyl)benzenesulfonic acid, 4-aminotoluene-2-sulfonic acid, 5-aminotoluene-2-sulfonic acid and/or 2-aminonaphthalene-4-sulfonic acid and/or salts thereof.

Clause 4. Process according to one of Clauses 1 and 2, characterized in that the organic compound bearing at least one group reactive to isocyanate groups having sulfonic acid or sulfonate groups B) are amino-functional sulfonic acids of the general formula (III) and/or salts thereof,

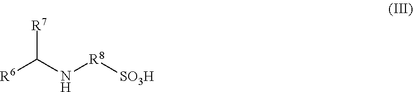

wherein in formula (III) R⁶ and R⁷ are each independently identical or different radicals and are hydrogen or saturated or unsaturated, linear or branched, aliphatic or cycloaliphatic or aromatic organic radicals having 1 to 18 carbon atoms, which are substituted or unsubstituted and/or comprise heteroatoms in the chain, wherein R⁶ and R⁷, in combination with each other and optionally with one further nitrogen atom or one oxygen atom, may form cycloaliphatic or heterocyclic rings having 3 to 8 carbon atoms, which may optionally be further substituted, and R⁸ is a linear or branched aliphatic radical having 2 to 6 carbon atoms.

Clause 5. Process according to Clause 4, characterized in that the organic compound bearing at least one group reactive to isocyanate groups having sulfonic acid or sulfonate groups B) are 2-isopropylaminoethane-1-sulfonic acid, 3-isopropylaminopropane-1-sulfonic acid, 4-isopropylaminobutane-1-sulfonic acid, 2-cyclohexylaminoethane-1-sulfonic acid, 3-cyclohexylaminopropane-1-sulfonic acid and/or 4-cyclohexylaminobutane-1-sulfonic acid and/or salts thereof.

Clause 6. Process according to any one of Clauses 1 to 5, characterized in that the organic compounds bearing at least one group reactive to isocyanate groups having sulfonic acid groups B) are present to an extent of at least 20 mol % with N,N-dimethylbutylamine, N,N-diethylmethylamine, N,N-diisopropylethylamine, N,N-dimethylcyclohexylamine, N-methylpiperidine and/or N-ethylmorpholine neutralized in the form of sulfonate groups.

Clause 7. Process according to any one of Clauses 1 to 6, characterized in that the non-ionic hydrophilic or hydrophobic organic compounds C) are pure polyethylene oxide polyether alcohols and/or mixed polyalkylene oxide polyether alcohols, the alkylene oxide units of which consist of ethylene oxide units to an extent of at least 70 mol %, and/or aliphatic alcohols or fatty acid ester alcohols which comprise in each case at least 8 carbon atoms.

Clause 8. Process according to any one of Clauses 1 to 7, characterized in that the radical scavengers and/or peroxide decomposers D) are phenols, thioethers and/or di- or trisubstituted phosphites.

Clause 9. Process according to Clause 8, characterized in that the radical scavengers and/or peroxide decomposers D) are 2,6-di-tert-butyl-4-methylphenol, esters of 3-(3,5-di-tert-butyl-4-hydroxyphenyl)propionic acid with aliphatic, branched C₇- to C₉-alcohols, octadecyl 3-(3,5-di-tert-butyl-4-hydroxyphenyl)propionate and/or thiodiethyl bis(3-(3,5-di-tert-butyl-4-hydroxyphenyl)propionate).

Clause 10. Process according to any one of Clauses 1 to 9, characterized in that the radical scavengers and/or peroxide decomposers D) are used singly and in any combinations with each other in amounts of 0.001 to 3.0% by weight, calculated as the total amount of radical scavengers and/or peroxide decomposers used, based on the amount of starting polyisocyanate A).

Clause 11. Polyisocyanates containing sulfonate groups, obtainable or obtained by a process according to any one of Clauses 1 to 10.

Clause 12. Use of one or more radical scavengers and/or peroxide decomposers D), preferably one or more sterically hindered phenols comprising 2,6-di-tert-butyl-4-methylphenol structures, for improving the incorporability of polyisocyanates containing sulfonate groups in aqueous systems.

Clause 13. Use of polyisocyanates containing sulfonate groups according to Clause 11 as starting components in the production of polyurethane plastics.

Clause 14. Coating composition comprising polyisocyanates containing sulfonate groups according to Clause 11.

Clause 15. Substrate, coated with a coating composition according to Clause 14 optionally cured by the action of heat.

1: A process for producing polyisocyanates containing sulfonate groups, comprising a reaction of
A) at least one polyisocyanate component having aliphatically, cycloaliphatically, araliphatically and/or aromatically bonded isocyanate groups with
B) at least one organic compound bearing at least one group reactive to isocyanate groups, which comprises one or more sulfonic acid and/or sulfonate groups, wherein the sulfonic acid groups are neutralized at least partially during and/or subsequent to the reaction of A) with B), and optionally
C) further non-ionic hydrophilic or hydrophobic organic compound having at least one group reactive to isocyanates,
wherein,
the reaction of the polyisocyanate component A) with the organic compound B) is carried out in the presence of at least one radical scavenger and/or peroxide decomposer D) and wherein the organic compound bearing at least one group reactive to isocyanate groups having sulfonic acid or sulfonate groups B) are hydroxy-, mercapto- and/or amino-functional sulfonic acids and/or salts thereof.

2: The process according to claim 1, wherein the polyisocyanate component A) are polyisocyanates having a uretdione, isocyanurate, allophanate, biuret, iminooxadiazinedione and/or oxadiazinetrione structure having exclusively aliphatically and/or cycloaliphatically bonded isocyanate groups.

3: The process according to claim 1, wherein the organic compound bearing at least one group reactive to isocyanate groups having sulfonic acid or sulfonate groups B) are 2-hydroxyethanesulfonic acid, 3-hydroxypropanesulfonic acid, 4-hydroxybenzenesulfonic acid, 2-(hydroxymethyl)benzenesulfonic acid, 4-aminotoluene-2-sulfonic acid, 5-aminotoluene-2-sulfonic acid and/or 2-aminonaphthalene-4-sulfonic acid and/or salts thereof.

4: The process according to claim 1, wherein the organic compound bearing at least one group reactive to isocyanate groups having sulfonic acid or sulfonate groups B) are amino-functional sulfonic acids of the general formula (III) and/or salts thereof, 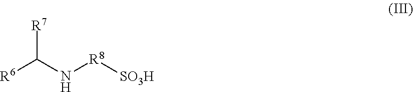
wherein in formula (III) R⁶ and R⁷ are each independently identical or different radicals and are hydrogen or saturated or unsaturated, linear or branched, aliphatic or cycloaliphatic or aromatic organic radicals having 1 to 18 carbon atoms, which are substituted or unsubstituted and/or comprise heteroatoms in the chain, wherein R⁶ and R⁷, in combination with each other and optionally with one further nitrogen atom or one oxygen atom, may form cycloaliphatic or heterocyclic rings having 3 to 8 carbon atoms, which may optionally be further substituted, and R⁸ is a linear or branched aliphatic radical having 2 to 6 carbon atoms.

5: The process according to claim 4, wherein the organic compound bearing at least one group reactive to isocyanate groups having sulfonic acid or sulfonate groups B) is selected from the group consisting of 2-isopropylaminoethane-1-sulfonic acid, 3-isopropylaminopropane-1-sulfonic acid, 4-isopropylaminobutane-1-sulfonic acid, 2-cyclohexylaminoethane-1-sulfonic acid, 3-cyclohexylaminopropane-1-sulfonic acid and/or 4-cyclohexylaminobutane-1-sulfonic acid and/or salts thereof.

6: The process according to claim 1, wherein the organic compounds bearing at least one group reactive to isocyanate groups having sulfonic acid groups B) are present to an extent of at least 20 mol % with N,N-dimethylbutylamine, N,N-diethylmethylamine, N,N-diisopropylethylamine, N,N-dimethylcyclohexylamine, N-methylpiperidine and/or N-ethylmorpholine neutralized in the form of sulfonate groups.

7: The process according to claim 1, wherein the non-ionic hydrophilic or hydrophobic organic compounds C) are pure polyethylene oxide polyether alcohols and/or mixed polyalkylene oxide polyether alcohols, the alkylene oxide units of which consist of ethylene oxide units to an extent of at least 70 mol %, and/or aliphatic alcohols or fatty acid ester alcohols which comprise in each case at least 8 carbon atoms.

8: The process according to claim 1, wherein the radical scavengers and/or peroxide decomposers D) are phenols, thioethers and/or di- or trisubstituted phosphites.

9: The process according to claim 8, wherein the radical scavengers and/or peroxide decomposers D) are 2,6-di-tert-butyl-4-methylphenol, esters of 3-(3,5-di-tert-butyl-4-hydroxyphenyl)propionic acid with aliphatic, branched C₇- to C₉-alcohols, octadecyl 3-(3,5-di-tert-butyl-4-hydroxyphenyl)propionate and/or thiodiethyl bis(3-(3,5-di-tert-butyl-4-hydroxyphenyl)propionate).

10: The process according to claim 1, wherein the radical scavengers and/or peroxide decomposers D) are used singly and in any combinations with each other in amounts of 0.001 to 3.0% by weight, calculated as the total amount of radical scavengers and/or peroxide decomposers used, based on the amount of starting polyisocyanate A).

11: A polyisocyanates containing sulfonate groups, obtainable or obtained by a process according to claim 1.

12: In a process for incorporation of polyisocyanates containing sulfonate groups in aqueous systems, the improvement comprising including one or more radical scavengers and/or peroxide decomposers D) according to claim 9.

13: In a process for the production of polyurethane plastics, the improvement comprising including the polyisocyanates containing sulfonate groups according to claim 11 as starting components.

14: A coating composition comprising polyisocyanates containing sulfonate groups according to claim 11.

15: A substrate, coated with a coating composition according to claim 14 optionally cured by heat.
